(19) United States
(12) Patent Application Publication
(10) Pub. No.: US 2012/0133514 A1
(43) Pub. Date: May 31, 2012

(54) PAUSE ADVISER SYSTEM AND USE THEREOF

(75) Inventor: Troels Mikael Palshof, Gentofte (DK)

(73) Assignee: ASP TECHNOLOGY APS, København K (DK)

(21) Appl. No.: 13/380,100

(22) PCT Filed: Jun. 30, 2009
(86) PCT No.: PCT/DK09/00163

§ 371 Date: Feb. 13, 2012

(51) Int. Cl. G08B 23/00

(52) U.S. Cl. 340/575

(57) ABSTRACT

The invention relates to a method comprising the steps of: establishing a personal user profile, representing the initial physiological conditions of said user, loading said personal user profile into said pause adviser system, by means of said pause adviser system establishing user stimuli on said output arrangement, by means of said pause adviser system establishing a fatigue level on the basis of: said reference data, said personal user profile, user input data obtained by said user input arrangement in response to said user stimuli, and sensor input data obtained from said sensor input arrangement, by means of a data processor, transforming said fatigue level into output advice data and communicating said output advice data to said output arrangement.

### BACKGROUND OF THE INVENTION

Great danger is imposed by drivers who fall asleep while driving. It is estimated that 3-15% of accidents with lethal result is due to drowsy driving. For subgroups of accidents drowsy driving is believed to cause up to 30% of accidents with lethal outcome. The need for a solution to the drowsy driving problem is paramount.

GB 2329057 describes a system for monitoring the alertness of a driver of a vehicle. The subsystems of the device may be integrated in the electrical system of the vehicle e.g. to reduce or monitor the engine speed or brakes. The alertness of the driver is determined based on voice recognition performed at random intervals or predetermined intervals.

WO96/16830 also describes a system for monitoring the alertness of a driver of a vehicle. The response time of the user is obtained by the system and this standard response time is used as reference when the system is testing the response of the driver. To respond to the system test, the driver activates a transducer extending through 360° around the steering wheel.

A problem related to the above is that they are rather sophisticated, difficult to install and expensive.

### SUMMARY

The invention relates to a method for advising a user of a pause adviser system of a preferred time for resting, said pause adviser system comprising:
output arrangement enabling said pause adviser system) to communicate output advise data to said user,
user input arrangement enabling said user to provide user input data to said pause adviser system,
sensor input arrangement providing sensor input data to said pause adviser system,
data storage circuitry for storing reference data,

said method comprising the steps of:
establishing a personal user profile, representing the initial physiological conditions of said user,
loading said personal user profile into said pause adviser system, by means of said pause adviser system establishing user stimuli on said output arrangement,
by means of said pause adviser system establishing a fatigue level on the basis of:
said reference data,
   said personal user profile,
   user input data obtained by said user input arrangement in response to said user stimuli, and
   sensor input data obtained from said sensor input arrangement,
by means of a data processor, transforming said fatigue level into output advice data and communicating said output advice data to said output arrangement.

The present invention is a very advantageous pause adviser system that informs the user about his/her fatigue level and in due time recommends the user to rest before he/she becomes critically fatigued. The pause adviser system is especially advantageous when used in relation to monotonous or complex tasks such as driving, surveillance, machine operation, reading, writing, etc. Such tasks demand perception, good judgment, adequate response time, reasonable physical capability, focus and concentration, etc. The pause adviser system advices the user to rest according to a user specific rest pattern and thereby over time the user is able to remain focused on the task. When initiated, the pause adviser system only requires a minimum of attention from the user and performs four important functions: a) in real time measures the user's fatigue level, b) continuously interacts with the user by running non-intrusive alertness maintaining tasks that keeps the user focused, c) recommends the user to take a break when the user approaches a critical fatigue level and d) calculates the length of the break required for the user to recuperate. If the user remembers to rest frequently e.g. during a drive from Denmark to Italy the risk of the driver falling asleep is minimized. Not only is the risk minimized, the driver is also more fit for the complete drive if the driver rests appropriately during the trip, instead of driving 800 kilometers before resting for the first time.

The optimal distribution of pauses or rests in between work or drive sessions e.g. during an 8 hour working day, is when the rests are distributed so that the user is able to work or drive with full attention throughout the session, then rest only as much as necessary to be able to work or drive with full attention during the next session.

The present invention is advantageous because it is capable of estimating the optimal time for the next rest and the duration of this rest, for the user to be as fit as possible to continue e.g. to work or drive. This is according to an advantageous embodiment of the invention done by correlating reference data with results of response tests of the user, contextual sensor measurement and with a personal user profile.

Reference data is a representation of scientifically validated fatigue data, user input data and sensor input data. Scientifically validated fatigue data may be represented by reference data e.g. by look-up tables, encapsulated algorithms, etc.

According to an advantageous embodiment of the invention scientifically valid data describes factors and periods of time affecting the fatigue level of a person. Hence, when the user of the pause adviser system loads his personal user profile, describing initial personal physiological conditions of the user, into the pause adviser system, the pause adviser system match the personal user profile with the reference data. Based on this match the pause adviser system knows with which frequency this specific user needs to rest. On top of this information the pause adviser system tests the response time of the user to stimuli communicated from the pause adviser system. This response time is a parameter in the calculation of current or real time fatigue level of the user; hence, in combination with the reference data and personal user profile the optimal time for the user to rest is estimated.

According to an advantageous embodiment of the invention, output advice data is advantageously communicated to the user via light and/or sound, because a combination of light and sound can be registered by the user no matter if it is night or day, or whether the environment is noisy or not.

The output advice data may include user stimuli, which may be used, by the pause adviser system, to attract the user's attention e.g. to obtain a response time of a user upon user stimuli. Furthermore, the output data may include advices or alarms to the user to which the user needs to respond, the result of this interaction between the user and the pause adviser system is used in the estimation of the fatigue level of the user. According to an advantageous embodiment of the invention, one category of user input data is advantageously obtained from a touch panel or by means of voice recognition and may be the response from the user upon user stimuli. A further category of user input data may also be obtained e.g. from the touch panel or mechanical switches. Information of this further category of user input data may be an offset adjustment of the user's fatigue level, adjustment of intensity of light or sound from the output arrangement if the user feels more fatigue than usual, etc.

According to an advantageous embodiment of the invention, sensor input data is data obtained from sensors such as light sensor, microphone, vibration sensor, touch panel, clock or timer, etc.

The light sensor obtains information or sensor input data on the ambient light conditions in the presence of the pause advisor system. This data may be used as reference for adjusting the intensity of light stimuli to the user. Furthermore, this data may be used as input to the estimation of the user's fatigue level.

The microphone obtains information or sensor input data of e.g. the background noise, used to adjust the intensity of the sound stimuli to the user. Furthermore, the microphone may be used to obtain user input data e.g. in form of voice response. It should be noted that one transducer may be used both as microphone and as speaker.

The vibration sensor obtains information or sensor input data of motion, if the pause advisor system e.g. is used in a car. This data is e.g. used to determine whether the engine of the car is stopped which indicates that the user is resting or a drive has ended. In the latter case this information may be used to activate standby mode or turn off the pause adviser system.

The touch panel is, as described above, used to obtain user input data such as e.g. a real time or current fatigue level adjustment, if the user e.g. feels more rested or more tired than usual or compared to what his/her personal user profile predicts.

The clock or timer is used to provide information of time into the estimations performed by the pause adviser system. The time domain is very advantageous because it enables the pause adviser system to calculate the duration of a drive or rest, provide information of time of the day and month of the year, etc.

According to an advantageous embodiment of the invention, the data storage circuitry may store reference data, sounds or light sequences, settings from previous use of the pause adviser system, etc. Furthermore, the data storage circuitry enables the pause adviser system to continuously store obtained sensor input data and user input data.

According to an advantageous embodiment of the invention, it may only be necessary to make the personal user profile once in the life time of the pause adviser system and this may preferably be before the user uses the pause adviser system for the first time. If the user's physiological conditions should change e.g. over years it is necessary and possible to perform a new personal user profile test and load the result of this test to the pause adviser system.

It should be noted that it is possible to load a plurality of personal user profiles to the pause adviser system; hence, a plurality of users may use the pause adviser system. Furthermore, it should be noted that it may be possible to erase or edit a personal user profile provided to the pause adviser system. This could be necessary e.g. if the physiological conditions of the user changes or that the user experiences that his/her capabilities to handle fatigue are either worsened or getting better.

Furthermore, it should be noted that the pause advisor system may be able to estimate the fatigue level of a user who has not loaded a personal user profile to the pause adviser system, but in this situation the estimated fatigue level may not be user specific.

According to an advantageous embodiment of the invention said pause advisor system may communicate with sensor or power units via wired or wireless communication.

In an embodiment of the invention, said personal user profile is established by means of additional resources.

According to an advantageous embodiment of the invention, the additional resources may be a site on the interne, a page in the manual to the pause adviser system, etc. The additional recourse comprises questions the user needs to answer, in order to derive the users personal user profile the user is categorized. Based on reference data related to the category of user with this personal user profile the fatigue level estimation and thereby the pause adviser system becomes at least partly user specific.

In an embodiment of the invention, said personal user profile is loaded into said pause adviser system by means of said user input arrangement.

According to an advantageous embodiment of the invention, the user input arrangement comprises mechanical, electric or wireless arrangements used to load the personal user profile into said pause adviser system.

When the personal user profile is obtained it has to be loaded to the pause adviser. This may be done e.g. by a mechanical switch which may be adjusted according to the personal user profile e.g. between 1-10 different steps representing 1-10 predefined personal user profiles. Alternatively, it may be possible to adjust the personal user profile by means of an electric switch, contact or other electronic equipment e.g. also by touching. Alternatively, it may be possible to load de personal user profile by means of wireless communication arrangements such as Bluetooth, infrared, wi-fi, etc.

The latter two possibilities enables an increased number of different personal user profiles, because the number of possible physical steps in a mechanical switch is less than the number of steps that e.g. can be software implemented.

In an embodiment of the invention, a current fatigue level of a user of said pause adviser system is loaded into said pause adviser system by means of said user input arrangement.

During use of the pause advisor system, under normal conditions, the user's physiological conditions, as described by the personal user profile, is together with interactions with the pause advisor system basis for calculating the fatigue level for the user. If the user for some reason deviates from the normal conditions e.g. feels more tired due to stress or a minimum of sleep, the user may perform an adjustment of the current fatigue level. The current fatigue level adjustment adds an offset to the baseline adjustment or affects the fatigue level estimation to take into account that the user has informed the pause adviser system of the fact that the user is more tired than usual. Likewise the user may adjust current fatigue level to inform the pause adviser system that the user is less fatigued.

In an embodiment of the invention, said pause adviser system comprises a timer arrangement, said timer arrangement providing time data.

According to an advantageous embodiment of the invention, the timer arrangement is a repetitive clock, watch, etc. from which it is possible to derive time data representing the time of the day, month of the year, duration of a drive or work session, etc. This time data is according to an embodiment of the invention an essential part of the fatigue level estimation.

In an embodiment of the invention, said time data provided by said timer arrangement is used by said pause adviser system to establish said fatigue level. The fatigue level of a user of the pause adviser system is affected by the time of the day of use of the pause adviser system. Humans are by nature diurnal (day orientated) as opposed to nocturnal (night orientated) beings, meaning that our physiological functions are geared towards day time activity and night time rest. This is also sometimes referred to as circadian rhythms. The human circadian rhythms are synchronized to one another by the internal biological clock, and entrained (daily reset) to the 24 hour day/night cycle by external time cues, namely the variation in sunlight and the increase in environmental and family activity around us. Hence, when it is dark the user tends to be more tired e.g. when driving, than when it is light outside. Furthermore, the fatigue level of a user is affected by the season of the year, hence, e.g. in Canada and Northern Europe during fall and winter it becomes dark in the afternoon and thereby the user is in a greater risk of getting tired in the afternoon in winter than in the afternoon in the summer.

Furthermore, it is possible to measure the time to the next rest, the duration of a rest, time since the last rest, etc.

Response time is closely related to the fatigue level of a person, when a person gets tired the person's response time increases. Therefore, it is advantageous to be able to measure the time from a stimuli is communicated from the output arrangement to the user responds to the stimuli via the user input arrangement. This time indicates if the person is tired or unfocused and even sometimes how tired the person is.

In an embodiment of the invention, said sensor input data represents the environment in which said pause adviser system is used.

The sensors of the pause adviser system are collecting data describing the environment or context in which the pause adviser system is used. In this way the pause adviser system is provided with information of e.g. ambient light intensity, in the ambience of the user or the pause adviser system which, as described, influences the fatigue level.

The sensors may also provide sensor input data comprising information of whether or not the car is moving or if the engine is turned off e.g. indicating whether the user is resting or driving.

In an embodiment of the invention, at least part of said sensor input data is provided by a vibration sensor.

Information of whether movement/motion is detected is very advantageous, especially if the pause adviser system is used in a car or truck, because vibration indicates whether or not the engine is started. This information may be used by the pause adviser system to register e.g. if the user is resting, the duration of a drive, to control power save functions of the pause adviser system, etc.

A vibration or movement sensor may according to an embodiment of the invention e.g. be a GPS (GPS; Global Positions System), accelerometer, piezo or capacitive acceleration sensor, omnidirectional micro vibration sensors or other mechanical or electrical devices adapted to sense vibrations, etc.

In an embodiment of the invention, said sensor input data provided by said vibration sensor is used as start and stop commands in the establishment of said fatigue level of said user.

According to an advanced embodiment of the invention, the vibration or motion sensor supplies data to the pause adviser system comprising information of whether the pause adviser system is exposed to vibrations or motion. This is advantageous because motion e.g. indicates that the user is driving which is used in the estimation or establishment of the fatigue level of the user. In the same way when the vibration or motion sensor does not supply vibration data to the pause adviser system, it indicates that the user is resting which is taken into account when the pause adviser system estimates or establishes the fatigue level of the user.

In other words, the input from the vibration sensor arrangement may according to an embodiment of the invention be applied to estimate whether the method results in the desired result, namely the user takes a break at the suggested time and/or that the length of the break is sufficient. Evidently, by incorporating these input data indicating whether and when a user is driving, it is possible to adjust the output advice accordingly.

In an embodiment of the invention, said output arrangement of said pause adviser system continuously communicates the real time fatigue level of the user.

It is a very advantageous feature that the user is able to monitor his current or real time fatigue level. Hence, if the user is informed that he will soon be advised to take a break, it becomes possible for the user to plan his work or drive accordingly. He may e.g. park the car or truck and rest before entering a highway or he may rest before starting a new task at the office. Preferably the user can monitor the fatigue level by means of light emitted from the output arrangement and be informed by light and sound when the recommended break or rest time is over.

In an embodiment of the invention, said output arrangement of said pause adviser system advises said user to rest,
said rest starting at said preferred time for resting, and
said preferred time for resting occurs when said fatigue level reaches a fatigue level threshold.

It is a very advantageous feature that the pause adviser system advices the user when the fatigue level threshold is reached that now the optimal time for resting has occurred. The advice is preferably communicated by means of the output arrangement, e.g. by light or sound, and because of he is reminded, the user does not need to plan or remember when to rest.

This fatigue level threshold is dynamic in the sense that it is partly determined by the user's response time in the interaction with the pause adviser system. The longer time from the user stimuli is communicated, to the response from the user is registered, the more tired the pause adviser system interprets the user to be. In this situation the pause adviser system e.g. lowers the fatigue level threshold whereby the recommendation to take a break will occur earlier than the original estimate.

In an embodiment of the invention, said pause adviser system communicates to said user when said rest is over.

It is a very advantageous feature that the pause adviser system informs the user when the rest is over. If the user is in a hurry he knows that the rest is only as long as necessary for continuing with a safe and sound fatigue level.

In an embodiment of the invention, an alarm is activated if said user fails to respond, via said user input arrangement, to said advice to rest.

When the fatigue level of the user is known, it is compared to a fatigue level threshold and if the fatigue level reaches or exceeds the fatigue level threshold the user is advised or recommended to rest. By interacting with the pause adviser system, the user needs to respond to the advice, to let the pause adviser system know that the advice is received by the user.

If the user does not respond to the advice to rest, within a time of e.g. 10 or 15 seconds, the advice is converted to an alarm, preferably be turning up the volume of the sound advising the user to rest, to a loud sound to get the users attention even if the user has fallen asleep.

When the alarm is activated the pause adviser system may be interpreted as an anti sleep system because the alarm will wake up the user if the user falls asleep and does not respond to user stimuli from the pause adviser system.

In an embodiment of the invention, said user overrules said alarm for a period of time by means of said user input arrangement.

It is very advantageous to be able to overrule or snooze the alarm or rest advise e.g. in the case where the pause adviser system is used in a car and the car is driving on a high way, with no exits near by. In this situation the alarm may be snoozed or postponed for a period of time of e.g. 1 to 10 minutes until the user gets the opportunity to stop the car and rest. The period of time may e.g. be random or following an exponential curve form so that the period the alarm or advice can be snoozed may be 5, 4, 4, 3, 3, 2, 2, 2, . . . , 2 minutes.

Another example where it might be very advantageous to be able to snooze the alarm is when the alarm is activated very close to the destination of e.g. a trip or at the end of a night shift at work. In this situation it may not give any sense to rest and the snooze opportunity is valuable.

In an embodiment of the invention, said pause adviser system comprising:
output arrangement in form of at least one illuminator and at least one speaker through which said pause adviser system communicates output advise data to said user,
user input arrangement in form of at least one touch panel through which said pause adviser system retrieves information from the user,
sensor input arrangement in form of at least one light sensor and at least one vibration sensor through which said pause adviser system retrieves information of the environment in which said pause adviser system is used, and
data storage circuitry for storing reference data and enabling said pause adviser system to continuously store said user input data and said sensor input data,
   said method comprising the steps of:
establishing a personal user profile, representing the initial physiological conditions of said user,
loading said personal user profile into said pause adviser system,
by means of said illuminator and said speaker said pause adviser system establishing user stimuli,
by means of said touch panel said pause adviser system retrieving the user's response time on said user stimuli,
by means of said light sensor and said vibrations sensor retrieving drive specific data, comprising information of a current drive,
by means of said personal user profile said response time and said drive specific data said pause adviser system establishing said fatigue level of said user, and
by means of a data processor, transforming said fatigue level into output advice data and communicating said output advice data to said illuminator and/or said speaker.

In an embodiment of the invention, said pause adviser system is implemented in a portable stand alone device.

The mobile implementation of the pause adviser system in a pause adviser device enables the user to use the pause adviser system in different locations such as in a car, truck, boot, office, etc.

Furthermore, the invention relates to a pause advisor system comprising a data processor implementing the method of claims 1-16.

In an advantageous embodiment of the invention, said pause adviser system is a device.

According to an advantageous embodiment of the invention, the pause adviser system device is portable which enables the user to use the pause adviser system in different locations such as in a car, truck, boot, office, etc.

Furthermore it is possible to mount the pause adviser system device by means of screws, glue, adhesive materials, hook and loop systems, etc.

### FIGURE LIST

FIG. 1 illustrates an overview of the pause advisor system,

FIG. 2a illustrates a conceptual use of the pause advisor system,

FIG. 2b illustrates a result of a conceptual use of the pause advisor system,

FIG. 2c illustrates a rest pattern reflecting the result of the conceptual use of the pause advisor system,

FIG. 3 illustrates a specific use of the pause advisor system, and

FIG. 4 illustrates interactions between the pause advisor system and additional recourses.

### DETAILED DESCRIPTION

The term “fatigue level” FL is used as a measure of how fit a user of the pause adviser system PAS is based on e.g. the user's U physiological conditions, how rested the user U feels, how long time the user U has been e.g. working or driving, etc.

The term “optimal time” is used to described the point in time where the user U of the pause adviser system PAS is advised to rest. The optimal time is estimated as described throughout this document i.e. in relation to driving; the optimal time is the point in time where the fatigue level FL indicates that the user U needs a rest to be able to continue the drive or work as focused as possible.

The term “rest” R is used to describe a pause or break. If a user U is at work the lunch break, a power nap, a walk, etc is considered as a rest. If a user U is driving a rest is considered as a stop where the user U e.g. stops the car, leaves the car, takes a nap, etc.

The term “estimation” is used to describe the “processing of data” which is necessary to obtain the fatigue level FL of the user U of the pause adviser system PAS. The estimation may preferably be performed by processing e.g. the following three categories of data.

The first category is data which scientifically has been identified to affect the fatigue level FL of a person. Preferably a representation of this data, e.g. the reference data RD, is stored in the pause adviser system PAS before the user U uses the pause adviser system PAS for the first time, e.g. before the user U buys the pause adviser system PAS.

The second data category is data loaded to the pause adviser system PAS before the user U takes the pause adviser system PAS in use for the first time, this data is also referred to as personal user profile PUP and is preferably loaded to the pause adviser system PAS by the user U.

The third data category is data obtained or recorded by the pause adviser system PAS during use as described below.

The term “stimuli” or user stimuli US is used to describe the alertness maintaining tasks carried out by interactions between the user U and the pause adviser system PAS. Hence, the user stimuli US is the part of the alertness maintaining interaction originating from the pause adviser system PAS to which the user U needs to respond. This correlation or processing of data may be controlled by an algorithm and this algorithm may, in various ways, be executed by one or more data processors DP. One example may be that the above-mentioned data, is stored in a data stored circuitry DSC such as a database or mechanically stored, e.g. by means of a switch, and from one of these storages the data processor DP accesses the information needed to estimate the fatigue level FL of the user U.

A second example may be that the above-mentioned data is encapsulated in an algorithm so that the algorithm in itself contains at least part of the data/information which is needed to estimate the fatigue level FL of the user U.

A third example may be that the above-mentioned data is replicated by an estimating algorithm; hence, the above mentioned data then constitutes the algorithm.

Data processor DB is understood as an electronic device—a data processing unit capable of processing data such as an integrated circuit, microcontrollers, micro processors, etc.

It should be noted that if nothing else is stated, the user U throughout this document is understood as the user U of the pause adviser system PAS and could be a person of both genders.

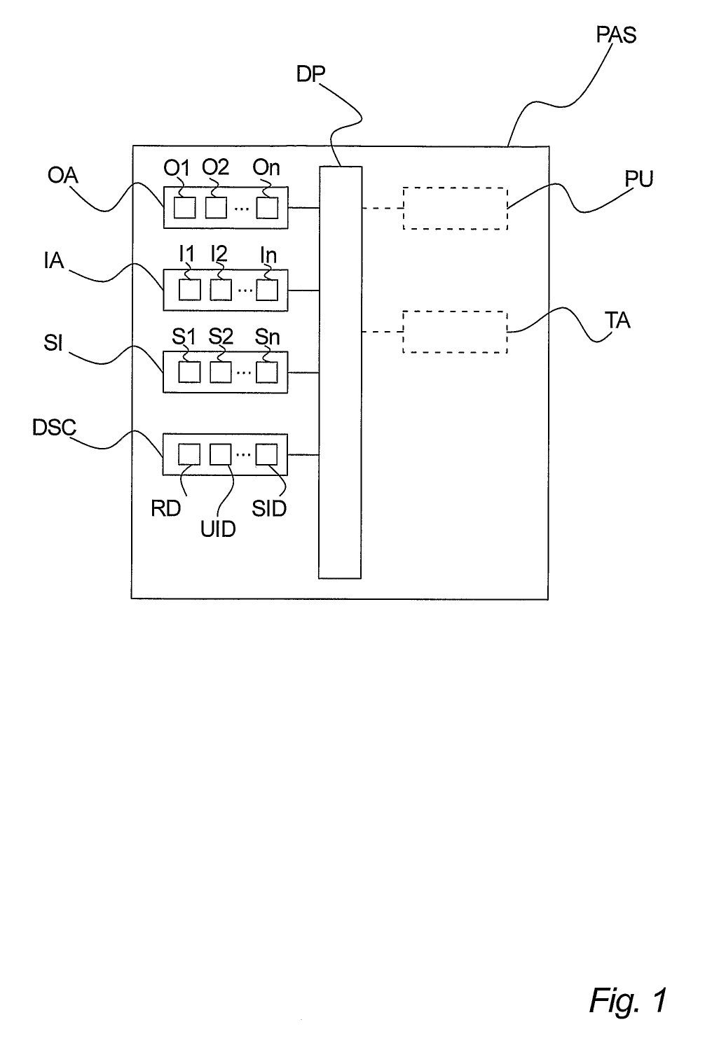

FIG. 1 illustrates the principles of a pause adviser system PAS according to an embodiment of the invention. The pause adviser system PAS comprises at least one user output arrangement OA, at least one user input arrangement IA, at least one sensor input arrangement SI at least one data processor DP and at least one data storage circuitry DSC.

Furthermore, the pause adviser system PAS may comprise at least one power unit PU and at least one timer arrangement TA.

The pause adviser system PAS may according to an embodiment of the invention be implemented in a stand alone device or as a part of or as a sub-element e.g. in a car, desktop or where ever users U need to be advised to rest. When the pause adviser system PAS is implemented in a portable stand alone device the pause adviser system PAS becomes mobile in the sense that it is movable and thereby the use of the pause adviser system PAS is not limited to only one physical location. Preferably a stand alone pause adviser system PAS may be used in a car while driving, at a desktop while working, at the office during night watch, etc.

The intention of using the pause adviser system PAS is to inform the user U of the current or real time fatigue level of the user U by means of the output arrangement OA. When the fatigue level FL passes a fatigue level threshold FLT, the user U is informed that it is now the optimal time to rest and the output arrangement OA recommends the user to take a break. Preferably the output arrangement OA also informs the user U of the optimal length of this break.

The output arrangement OA enables the pause adviser system PAS to communicate output advise data OAD to the user U. The output advice data OAD may inform the user U of the user's U current fatigue level FL in real time or at least with predefined or random time intervals. By real time is understood as fast as the pause adviser system PAS is able to provide output advise data OAD. Furthermore, the output advise data OAD may be used for informing the user U that the pause adviser system PAS soon will require the user's U attention. If e.g. the pause adviser system PAS is going to use a loud sound to inform the user U that interaction between the user U and the pause adviser system PAS is required, a short soft flash may be used before the sound to prevent the user U from getting a shock.

One example of a sub-output arrangement O1 of the output arrangement OA is a transducer such as a speaker which is capable of transforming a representation of the output advice data OAD into an audio signal such as tones, talking voice, etc. The speaker may communicate predetermined sound sequences which are stored in the data storage circuitry DSC and the intensity of these sound sequences may, depending on the purpose e.g. advice or alarm, be up to and over 90 dB.

Another example of a sub-output arrangement O2 of the output arrangement OA is an illuminator which is capable of transforming a representation of the output advice data OAD into light. Such illuminator is preferably a LED (LED; Light Emitting Diode) but may also create light based on e.g. short arc gap, wolfram thread, fiber or optics or other technologies. The illuminator is preferably communicating predetermined light sequences stored in the data storage circuitry DSC e.g. in combination with predetermined sound sequences.

Further examples of a sub-output arrangement On of the output arrangement OA may be arrangements creating vibration, heat, cold, etc.

The user input arrangement IA enables the user U to provide user input data UID to the pause adviser system PAS. Through the user input arrangement IA the user U is capable of interacting with the pause adviser system PAS, e.g. respond to an advice from the pause adviser system PAS or adjusting the current fatigue level CF as described below. Another use of the user input arrangement IA is to load information to the pause adviser system PAS, e.g. loading a personal user profile PUP to the pause adviser system PAS, which is needed for the pause adviser system PAS to operate user specifically as described below.

One example of a sub-user input arrangement I1 of the user input arrangement IA is a transducer such as a microphone which is capable of registering and transforming the voice of the user U into user input data UID. Furthermore, a microphone may record background noise and with such user input data UID it is possible to adjust the volume of advises from the output arrangement OA relative to the background noise.

Another example of a sub-user input arrangement I2 of the user input arrangement IA is a touch panel. With a touch panel it is possible for the user to communicate e.g. adjust or respond the pause adviser system PAS only by touching, which does not require notable attention from the user U.

Further examples of a sub-user input arrangement In of the user input arrangement IA may be mechanical or electric switches or arrangements for receiving data e.g. wireless data communication.

Furthermore, it should be noted that in an embodiment of the invention where data communication is possible or where the pause adviser system PAS comprises a microphone, the user U may load or save his own sound and light sequences to the pause adviser system PAS.

The sensor input arrangement S1 of the pause adviser system PAS is providing information of the environment in which the pause adviser system PAS operates. This information may be relevant for the fatigue level FL of the user U.

One example of a sensor S1 of the sensor input arrangement SI is a light sensor for transforming the light intensity, e.g. inside a car or an office, into sensor input data SID for use in the estimation of the user's U fatigue level FL. Such light sensor Si may e.g. be optical detectors, photodiodes, photoresistors, etc.

Another example of a sensor S2 of the sensor input arrangement SI is a vibration sensor for transforming vibrations or motions, e.g. of a dashboard of a car, into sensor input data SID for use in the estimation of the user's U fatigue level FL. Such vibration sensor S2 may e.g. be an accelerometer.

Yet another example of a sensor Sn of the sensor input arrangement SI is a touch sensor for transforming e.g. the touch of a user U into sensor input data SID for use in the estimation of the user's U fatigue level FL. Such touch sensor Sn may e.g. be based on capacitive, resistive or infrared technologies. It should be noted that other technologies than the mentioned also may be used.

The data storage circuitry DSC of the pause adviser system PAS is intended for storing data or a representation of data such as the reference data RD, input user data IUD received by the user input arrangement IA, sensors input data SID received by the sensor input arrangement SI, etc.

The reference data RD may both represent data obtained by or provided to the pause adviser system PAS, e.g. during an ongoing trip in a car, provided to the pause adviser system PAS by the user U before the trip starts and scientific information of general conditions affecting the fatigue level FL of a user U.

Data from each of these categories of data may be used by the pause adviser system PAS when estimating the fatigue level FL of a user U.

The timer arrangement TA, of the pause adviser system PAS, provides a time domain to the estimation of the fatigue level FL. The timer arrangement TA may e.g. be a digital timer or clock signal from which it is possible to derive e.g. year, month, day and/or time of the day. This may according to an embodiment of the invention be possible either when the pause adviser system PAS is in use, in standby or turned off.

The data processor DP may be used in the pause adviser system PAS for calculating the fatigue level FL of the user U based on the above-described user input data UID, sensor input data SID, reference data RD and time data TD. Furthermore, the data processor DP may be responsible for the saving, communicating and processing of data within the pause advisor system PAS and communication with the surroundings.

The power unit PU is supplying the pause adviser system PAS with energy from an energy source such as a battery or generator.

The communication between the illustrated elements of the pause adviser system PAS is illustrated as going through the data processor DP, but this is only one of a plurality of ways of connecting the different elements of the pause adviser system PAS.

Furthermore, it should be noted that it is possible to include further elements to the pause advise system PAS if necessary according to a specific use.

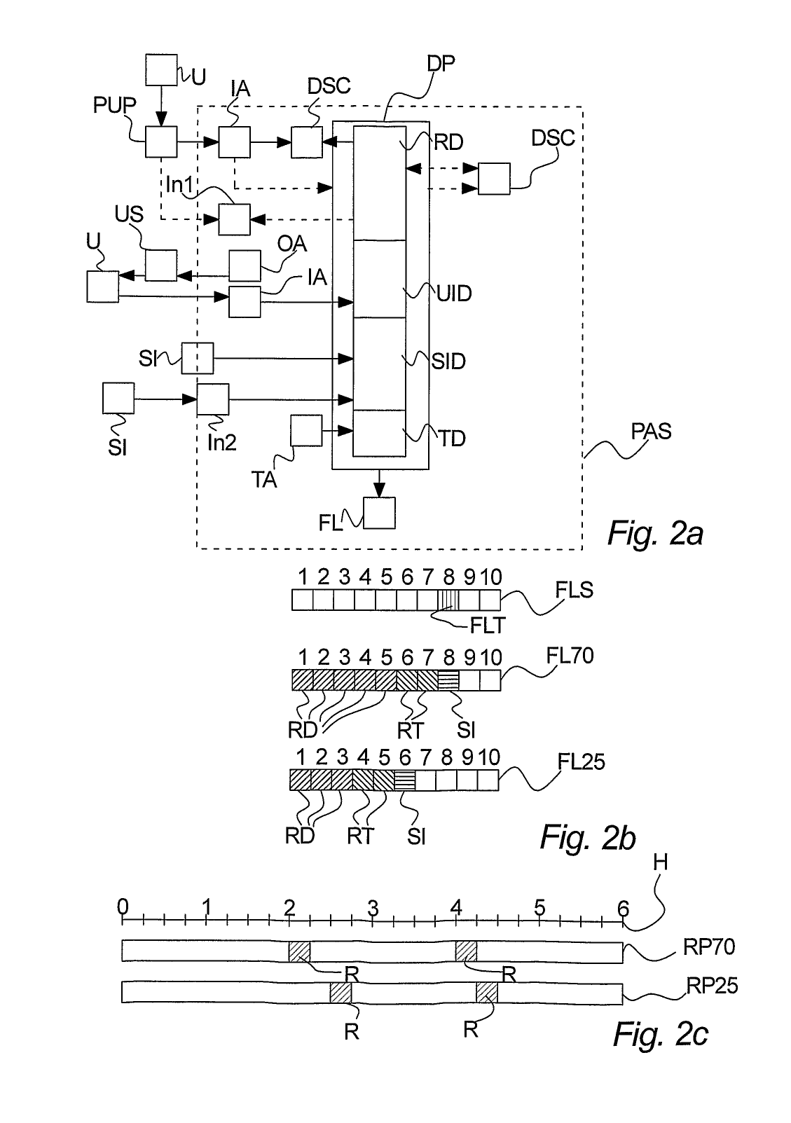

FIG. 2a-2c illustrate one way of using the pause adviser system PAS and estimating the fatigue level FL of the user U. It is common knowledge that humans need to rest and that at the end of long day of work a person feels more fatigued if the person has not rested during the day, compared to a person who has rested during the day. It is scientifically shown that a person's optimal rest pattern RP i.e. frequency and length of the rests during a work- or drive sequence, among other things, depends on the physical conditions of the person. The other things which affect the rest pattern RP are e.g. time of the day, length of the sequence, ambient light conditions, length of a break, etc.

Consequently, a 70 year old person weighing 110 kg driving 6 hours during the night has a different rest pattern RP during the 6 hour's drive, than a 25 year old person weighing 70 kg. FIG. 2b illustrates how the pause adviser system PAS estimates theses two persons' fatigue level FL differently and FIG. 2c illustrates how the pause adviser system PAS advises these two persons of their different optimal rest patterns RP during the same drive.

FIG. 2a illustrates one conceptual use of the pause adviser system PAS and should therefore not be considered as limiting for the scope of the invention. The illustrated use is the same no matter the age and gender of the user U. The user U provides a personal user profile PUP to the pause adviser system PAS e.g. to a data storage circuitry DSC via the user input arrangement IA. Alternatively, the personal user profile PUP may via a data processor DP be stored in the data storage circuitry DSC or if the user input arrangement IA e.g. comprises a mechanical sub-user input arrangement In1 , the personal user profile PUP is mechanically stored.

The data processor DP then retrieves data e.g. represented by the reference data RD from the data storage circuitry DSC matching the personal user profile PUP. This reference data RD is then used in the estimation of the fatigue level FL of the user U.

To estimate the fatigue level FL user input data UID such as information of response time RT of the user's U response to user stimuli US communicated to the user U from the output arrangement OA is needed.

Furthermore, sensor input data SID such as information of ambient light conditions is needed. This sensor input data SID is obtained from sensor input arrangement SI which may be located partly within and partly outside the pause advisor system PAS.

A sensor input arrangement SI may also be located apart form the pause adviser system PAS. From the remote location, in relation to the user U or pause advisor system PAS, the remote sensor input arrangement SI communicates sensor input data SID to a sub-user input arrangement In2 and from here it is used in the estimation of the user's U fatigue level FL. This sensor input data SID may e.g. be communicated via wireless data communication such as Bluetooth or other wireless communication means and protocols.

Furthermore, the timer arrangement TA provides time data TD to the estimation of the fatigue level FL or the user U. The timer arrangement TA may e.g. be a GPS (GPS; Global Position System), atomic timer, high precision clock, etc. from the timer arrangement TA the time data TD may be obtained directly or it may be derived from a signal from the timer arrangement TA.

It should be noted that the timer arrangement TA or other elements of the pause adviser system PAS may be supplied with power from a separate power source dedicated to energize the timer arrangement TA or the other element.

From the time data TD, sensor input data SID, user input data UID and reference data RD it is possible to estimate the fatigue level FL of a user U and thereby estimate the optimal rest pattern RP of the user.

FIG. 2b is a simplified and explanatory illustration of the how the pause adviser system PAS estimates the fatigue level FL70 of a 70 year old user U and the fatigue level FL25 of a 25 year old user U. In this example the users U need to rest when the fatigue level FL reaches a fatigue level threshold FLT at 8 out of 10 on a fatigue level scale FLS.

When the 70 year old user U has loaded his personal user profile PUP, the pause adviser system PAS retrieves data e.g. represented by the reference data RD from the data storage circuitry DSC, matching the specific personal user profile PUP. The reference data RD matching the personal user profile PUP of the 70 year old user U adds an offset of 5 to the fatigue level FL70.

The response time RT, of the 70 year old user U to the user stimuli US of the response test performed by the pause advisor system PAS adds a further contribution of 2 to the fatigue level FL70, because the 70 year old user's U response time RT was not convincingly fast. If the reaction time RT was as fast as expected, the reaction time RT would not have contributed to the fatigue level FL75.

The last contribution to the fatigue level FL70 in this example is provided by the sensor input arrangement SI, because the user drives at dark night, the sensor input arrangement SI adds a further contribution of 1 to the fatigue level FL70. Therefore, the 70 year old user U needs to rest because the total of contributions to the fatigue level FL70 is 5+2+1=8, which equals the fatigue level threshold FLT.

Still according to FIG. 2b, the fatigue level FL25 of the 25 year old user U is also offset by data represented by the reference data RD related to the personal user profile PUP of the 25 year old user U. But because of the difference in age the offset on the fatigue level FL25 from the reference data RD related to the 25 year old user U is only 3.

The reaction time RT of the 25 year old user U is similar to the reaction time RT of the 70 year old user; hence, the reaction time RT contributes with 2 to the fatigue level FL25.

The 25 year old user's U drive is also at dark night; hence, the sensor input arrangement SI contributes with 1 to the fatigue level FL25.

Therefore, the total fatigue level FL25 of the 25 year old user U is 3+1+2=6, accordingly the 25 year old user U still has not reached the fatigue level threshold FLT at 8 and may continue without being advised to rest by the pause adviser system PAS.

Since the response time RT of the 25 year old user U were slower than expected from a 25 year old user U, it was comparable with the response time RT of the 70 year old user U, the pause adviser system PAS is going to test the response time RT of the 25 year old user with a relative high frequency. This is done to test if the slow response time RT was an event only occurring once or if the response time RT is slow in successive reaction tests, which could indicate that the user U is tired and needs rest. In the latter case this will be communicated to the user U by the pause adviser system PAS.

FIG. 2c illustrates a typically rest pattern RP70, PR25 from a 70 and a 25 year old user U respectfully, relative to a time line H divided in hours from 0 to 6 hours.

The rest pattern RP70 of a 70 year old user U illustrates the need of a rest R after a first drive sequence of 2 hours while the rest pattern RP25 of a 25 year old user U illustrates the need of a rest R after a first drive sequence of 2.5 hours.

The illustrated rest patterns RP70 and RP25 are only used to illustrate that differences occurs e.g. because of age of the user U. Of course, since a lot of different data is used to calculate or estimate the fatigue level FL, these rest patterns RP70, RP25 differs from person to person.

Furthermore, it should be noted that the rest patterns RP70, RP25 are the optimal rest patterns to the specific user U, advised by the pause adviser system PAS. The users U are free to rest R before it is advised by the pause adviser system PAS. Such a not advised rest R (not illustrated) is taken into account in the estimation of the fatigue level FL when the drive continues.

Furthermore, is should be noted that the intervals between the rest R in the rest pattern RP25 are not of the same duration. Firstly, this is because data represented by the reference data RD prescribes that a second sequence should be shorter than a first sequence, but the reason could also be that the user's U response time RT to a user stimuli US is slow, indicating that the user U needs a rest R.

Furthermore, it should be noted that if one of the users U feels fit he may snooze the advised rest R, to arrive at the destination sooner. In this way the user U may continue driving as before while overruling the advice from the pause adviser system PAS.

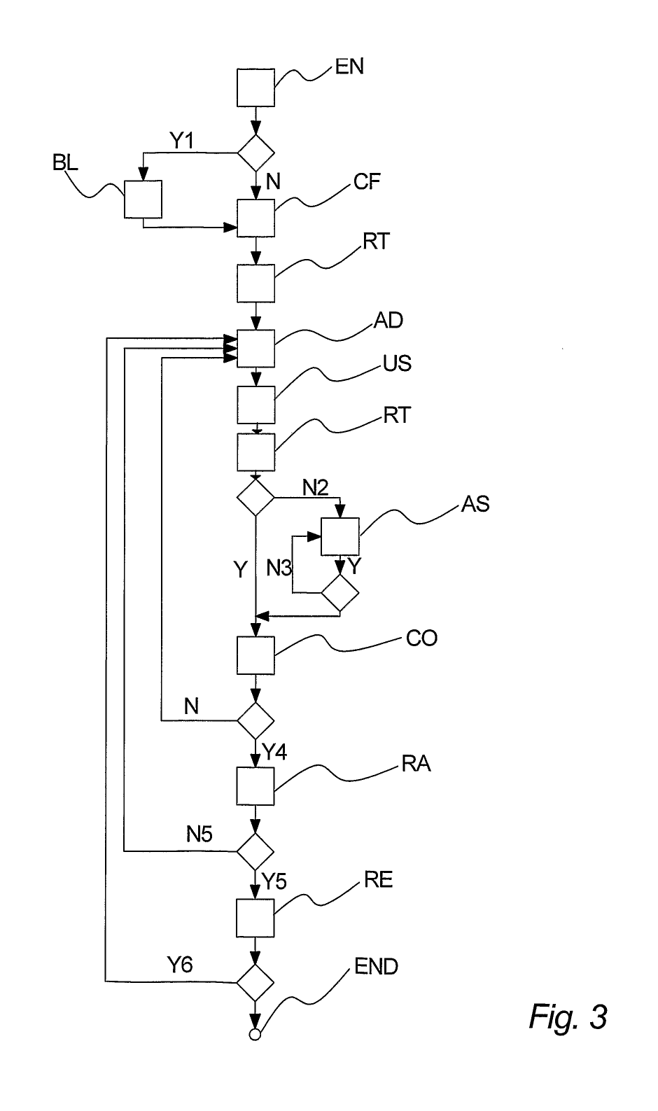

FIG. 3 illustrates a flow chart describing a preferred use of the invention where the pause adviser system PAS is integrated in a portable stand alone device and the invention should therefore not be understood as limited to the description of FIG. 3. Before using the pause advising system PAS it has to be energized EN, preferably from one or more batteries such as AAA batteries installed in the power unit PU. When energized the pause adviser system PAS it is ready for use.

Firstly, the user U needs to decide whether or not the pause adviser system PAS has to be provided with a personal user profile PUP. A baseline BL configuration is recommended because it enables the pause adviser system PAS to estimate the fatigue level FL of the user U more accurately.

If it is chosen to perform the baseline BL configuration Y1, a personal user profile PUP describing the physiological conditions of the user U e.g. in terms of age, weight, gender, etc. is created and loaded to the pause adviser system PAS via the user input arrangement IA.

This personal user profile PUP categorizes the user U in one of a number of predefined categories which in the pause adviser system PAS is used as an offset in the estimation of the fatigue level FL of the user U. An old user with a high BMI (BMI; Body Mass Index) statistically belongs to a category which, e.g. when driving a car, more often needs a break than a young user with normal BMI. With the personal user profile PUP provided to the pause adviser system PAS, the pause adviser system PAS requires interaction more frequently from the old user having a high BMI than from the young user having a normal BMI.

It is at any time possible to perform a current fatigue level adjustment CF using the user input arrangement IA. If the user U of the pause adviser system PAS e.g. before or during a drive feels more tired than usual, the current fatigue level adjustment CF can be used to add an offset to the pause adviser system PAS. This offset adjustment is taken into account when the pause adviser system PAS estimates the fatigue level FL and will e.g. require more frequent interaction between the user and the pause adviser system PAS.

The current fatigue level adjustment CF may of course also be used reversed in case the user feels more fit than usual and therefore does not need to rest as frequently as usual.

When the offset from the baseline BL and the current fatigue level adjustment CF is provided to the pause adviser system PAS, the pause adviser system PAS needs reference information of the response time RT of the user U. The pause adviser system PAS obtains this reference information of the users U by one or more random tests preferably early in e.g. a drive sequence to obtain reference information from the user, when the user is still focused on the drive. A random test may e.g. be performed by means of light or sound from the output arrangement OA to which the user U response via the user input arrangement IA e.g. by touch or voice recognition.

During use of the pause adviser system PAS e.g. during a drive, the pause adviser system PAS continuously acquire data AD describing e.g. duration of the drive, vibrations, time of day, response time RT to reactions tests, etc. This acquired data AD is by the pause adviser system PAS correlated with the baseline BL, actual AC and reaction test information, to estimate the user's U fatigue level FL and thereby the optimal time for the user's U next rest.

The user's response time RT to user stimuli US from the output arrangement OA is continuously tested. The output arrangement OA of the pause adviser system PAS communicates user stimuli US such as a test signal, e.g. one or more illuminators lights up and/or a speaker makes a sound. The time from the test signal is activated by the pause adviser system PAS to a respond from the user U is registered is then measured by the pause adviser system PAS.

If the user U does not respond N2 by activating the user input arrangement IA an alarm signal AS, preferably a sound, increases significantly and the sound may continue to increase ending in an alarm if the user U does not respond N3 by activating the user input arrangement IA. The alarm is reset e.g. if the input arrangement IA is activated.

After a sequence where the user U did not respond appropriately to the user stimuli US, the user U is tested again within a short period of time e.g. within 3 minutes.

The response time RT of the driver is measured and indicates or reflects the fatigue level FL of the user U and is used in the pause adviser system PAS to determine when the next test of the driver's response time RT is performed.

Furthermore, the response time RT of the driver is correlated CO with the information obtained by the pause adviser system PAS as described above. The result of this correlation CO is an estimate of the fatigue level FL of the user U and can be used to estimate when the user U preferably should take the next rest.

If the fatigue level FL based on the above correlation CO of data passes a fatigue level threshold Y4, the output arrangement OA of the pause adviser system PAS advises the user U to rest RA and rest RE. It is now up to the user U to decide how to follow the advice e.g. by instantly Y5 pulling over to rest RE or later N5 if the user U e.g. feels fit or because the user U drives on a highway with no exit near by. In the latter case it is possible to snooze the rest advice RA for a period of time of e.g. 1 to 10 minutes; hence, it becomes possible to drive to the nearest exit and take the break.

If the user U decides to snooze the rest advice RA, the pause adviser system PAS continues to acquire data AD and when the predefined snooze period ends, a new rest advice RA is communicated to the user.

It should be mentioned that there does not have to be a limit on the number of times the user U may use the snooze function. Furthermore, it should be mentioned that during a snooze period the pause adviser system PAS may operate normally as described above.

When the user U pulls over to rest RE, either voluntarily or because the user U has received a rest advice RA by the pause adviser system PAS, it is registered by the sensor input arrangement SI and the length e.g. in minutes of the rest RE may then be determined e.g. by means of the timer arrangement TA.

The pause adviser system PAS then uses information of the length of the rest RE to decrease the remaining time of the advised rest RE. When the advised rest RE is completed the output arrangement OA informs the user U that the fatigue level FL is decreased enough to continue Y6.

If the user U rests without having received a rest advice RA, the measured length of the rest RE is used when the pause adviser system PAS is estimating the time to the next rest advice RA. Hence, the pause adviser system PAS estimates the effect of the voluntary rest RE on the fatigue level FL of the user U and the user U continues the trip with a decreased fatigue level FL.

After a rest RE, whether it is voluntary or not, the drive may be continued and the pause adviser system PAS again starts to acquire data AD, obtain response time RT of the driver, correlated CO data, etc. until the pause adviser system PAS again communicates a rest advice RA to the user U.

It should be noted that because of the fact that the response time RT of the user U is used in the pause adviser system PAS, the time between two following rest advices RA may not be identical—the longer response time RT, to shorter time between the rest advices RA.

Still according to FIG. 3, if a new driver takes over, the pause adviser system PAS needs to be informed. If the new driver has the same personal user profile PUP as the previous driver, there is no need for a baseline BL configuration, which is contrary to the situation where the two drivers are not represented by the same personal user profiles PUP.

Whether or not the baseline BL configuration is made, the new driver has the same possibilities for interacting with the pause adviser system PAS as described above in relation to the first driver.

It should be mentioned that the drive specific data obtained by the pause adviser system PAS during the drive with the first driver may be reset when the new driver continues the drive. The reset of data may be performed by performing a baseline BL adjustment or by means of interactions between the user and the user input arrangement IA. Such interactions could e.g. be the user U touching the touch panel in a predetermined amount of time, of e.g. 10 seconds, the pause adviser system PAS may then respond to this interaction by a sound or light sequence, to inform the user U that the drive specific data is reset. Furthermore, the pause adviser system PAS is reset for drive specific data after a period of time where the pause adviser system PAS has not been in use, such period could e.g. be 5-10 hours.

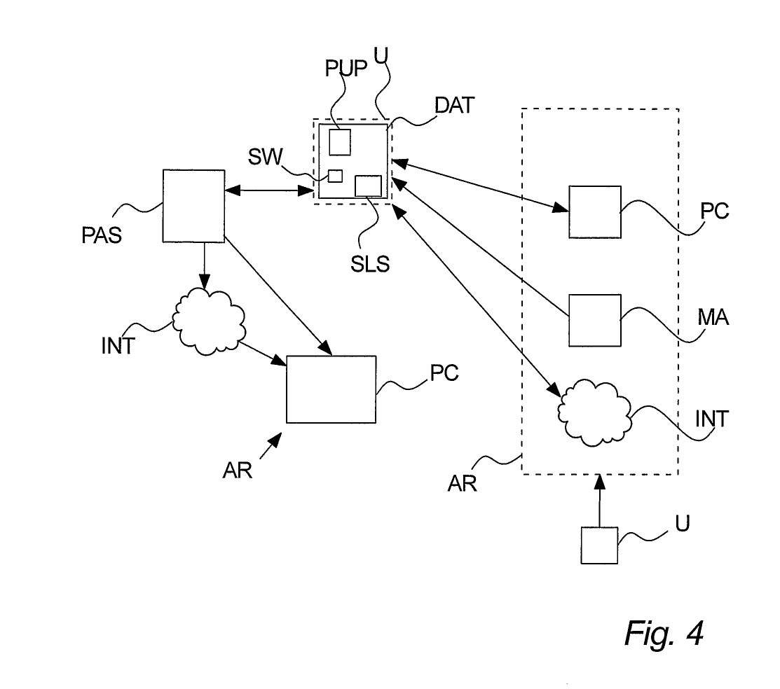

FIG. 4 illustrates the pause advisor system PAS communicating with additional recourses AR such as e.g. a personal computer PC, a manual MA, the internet INT, etc. From one or more of these additional recourses AR the user U may communicate data DAT such as e.g. the personal user profile PUP, sound and light sequences SLS, updates of software SW, etc. to the pause advisor system PAS. The personal user profile PUP can also be made by utilising the additional recourses AR and the user U then manually loads it to the pause advisor system PAS.

In an embodiment of the invention, the pause advisor system PAS may also be able to communicate to the additional recourses AR such as a personal computer PC e.g. via the internet INT. Then the user U may use data obtained by the pause advisor system PAS for statistics, publish in a community on the internet, etc.

It should be noted that according to an embodiment of the invention it is possible to combine features from each of the mentioned figures and embodiments in one pause adviser system PAS.

1. A method for advising a user of a pause adviser system of a preferred time for resting, said pause adviser system comprising:
output arrangement enabling said pause adviser system to communicate output advise data to said user,
user input arrangement enabling said user to provide user input data to said pause adviser system,
sensor input arrangement providing sensor input data to said pause adviser system,
data storage circuitry for storing reference data, said method comprising the steps of:
establishing a personal user profile representing the initial physiological conditions of said user,
loading said personal user profile into said pause adviser system,
by means of said pause adviser system establishing user stimuli on said output arrangement,
by means of said pause adviser system establishing a fatigue level on the basis of:
said reference data,
said personal user profile,
user input data obtained by said user input arrangement in response to said user stimuli, and
sensor input data obtained from said sensor input arrangement,
by means of a data processor transforming said fatigue level into output advice data and communicating said output advice data to said output arrangement.

2. The method according to claim 1, wherein said personal user profile is established by means of additional resources.

3. The method according to claim 1, wherein said personal user profile is loaded into said pause adviser system by means of said user input arrangement.

4. The method according to claim 1, wherein a current fatigue level of a user of said pause adviser system is loaded into said pause adviser system by means of said user input arrangement.

5. The method according to claim 1, wherein said pause adviser system comprises a timer arrangement, said timer arrangement providing time data.

6. The method according to claim 5, wherein said time data provided by said timer arrangement is used by said pause adviser system to establish said fatigue level.

7. The method according to claim 1, wherein said sensor input data represents the environment in which said pause adviser system is used.

8. The method according to claim 1, wherein at least part of said sensor input data provided by a vibration sensor.

9. The method according to claim 8, wherein said sensor input data provided by said vibration sensor is used as start and stop commands in the establishment of said fatigue level of said user.

10. The method according to claim 1, wherein said output arrangement of said pause adviser system continuously communicates the real time fatigue level of the user.

11. The method according to claim 1, wherein said output arrangement of said pause adviser system advises said user to rest,
said rest starting at said preferred time for resting, and
said preferred time for resting occurs when said fatigue level reaches a fatigue level threshold.

12. The method according to claim 1, wherein said pause adviser system communicates to said user when said rest is over.

13. The method according to claim 1, wherein an alarm is activated if said user fails to respond via said user input arrangement to said advice to rest.

14. The method according to claim 13, wherein said user overrules said alarm for a period of time by means of said user input arrangement.

15. The method according to claim 1, wherein said pause adviser system comprising:
output arrangement in form of at least one illuminator and at least one speaker through which said pause adviser system communicates output advise data to said user,
user input arrangement in form of at least one touch panel through which said pause adviser system retrieves information from the user,
sensor input arrangement in form of at least one light sensor and at least one vibration sensor through which said pause adviser system retrieves information of the environment in which said pause adviser system is used, and
data storage circuitry for storing reference data and enabling said pause adviser system to continuously store said user input data and said sensor input data,
said method comprising the steps of:
establishing a personal user profile representing the initial physiological conditions of said user,
loading said personal user profile into said pause adviser system,
by means of said illuminator and said speaker said pause adviser system establishing user stimuli,
by means of said touch panel said pause adviser system retrieving the user's response time on said user stimuli,
by means of said light sensor and said vibrations sensor retrieving drive specific data, comprising information of a current drive
by means of said personal user profile, said response time and said drive specific data said pause adviser system establishing said fatigue level of said user, and
by means of a data processor transforming said fatigue level into output advice data and communicating said output advice data to said illuminator and/or said speaker.

16. The method according to claim 1, wherein said pause adviser system is implemented in a portable stand alone device.

17. A pause advisor system for advising a user of a preferred time for resting comprising a data processor implementing the method of claim 1.

18. The pause advisor system according to claim 17, wherein said pause adviser system is a device.

19. The method according to claim 1, wherein said data processor retrieves data represented by said reference data from said data storage circuitry matching said personal user profile, and
using said retrieved data represented by said reference data so as to estimate the fatigue level of the user.

20. A portable stand-alone device comprising a pause adviser system for advising a user of a preferred time for resting, said pause adviser system comprising:
output arrangement enabling said pause adviser system to communicate output advise data to said user,
user input arrangement enabling said user to provide user input data to said pause adviser system,
sensor input arrangement providing sensor input data to said pause adviser system,
data storage circuitry for storing reference data, said method comprising the steps of:
establishing a personal user profile representing the initial physiological conditions of said user,
loading said personal user profile into said pause adviser system,
by means of said pause adviser system establishing user stimuli on said output arrangement,
by means of said pause adviser system establishing a fatigue level on the basis of:
said reference data,
said personal user profile,
user input data obtained by said user input arrangement in response to said user stimuli, and
sensor input data obtained from said sensor input arrangement,
by means of a data processor transforming said fatigue level into output advice data and communicating said output advice data to said output arrangement.
